(19) United States
(12) Patent Application Publication
(10) Pub. No.: US 2008/0063914 A1
(43) Pub. Date: Mar. 13, 2008

(54) High temperature polymer electrolyte membranes and membrane electrode assemblies based on blends of aromatic polyethers

(76) Inventors: Nora Gourdoupi, Patras (GR); Maria Daletou, Patras (GR); Stylianos Neophytides, Patras (GR); Joannis Kallitsis, Patras (GR)

Correspondence Address: EDWARDS ANGELL PALMER & DODGE LLP, P.O. BOX 55874, BOSTON, MA, 02205, US

(21) Appl. No.: 11/805,402

(22) Filed: May 23, 2007

Related U.S. Application Data
(60) Provisional application No. 60/843,800, filed on Sep. 11, 2006.

(51) Int. Cl. H01M 4/92; B01J 23/42; B01J 23/46; C08G 65/00

(52) U.S. Cl. 429/29; 502/101; 502/180; 525/417

(57) ABSTRACT

Featured are polymer electrolyte membranes based on blends of aromatic polyethers containing pyridine units in the main chain. Preferred membranes can show excellent mechanical properties and exceptional thermal and oxidative stability. Preferred polymer blends can be easily doped with inorganic acids such as phosphoric acid resulting in ionically conducting membrane.

### CROSS REFERENCE TO RELATED APPLICATIONS

This application claims priority to and the benefit of Provisional U.S. Application Ser. No. 60/843,800, filed Sep. 11, 2006, the entire contents of which are incorporated herein by reference.

### FIELD OF THE INVENTION

This invention is related to the development of new polymer electrolyte membranes composed of polymeric blends of aromatic polyethers containing pyridine units in the main chain. The membranes combine excellent mechanical properties with high thermal and oxidative stability. Controlled morphology is also obtained depending on the copolymer structure and the blend composition. The membranes allow high acid uptake resulting in high ionic conductivities in the range of 10⁻² S/cm. Membrane electrode assemblies are prepared by pressing the acid doped membrane and the gas diffusion electrodes into a single cell. The gas diffusion electrodes are prepared by applying a slurry of a carbon supported platinum catalyst and a polymer solution, onto a hydrophobic carbon substrate.

### BACKGROUND INFORMATION

Polymer electrolyte membrane fuel cells have gained increased attention for use in stationary, as well as automobile applications due to their high efficiency and the potential for zero-emissions during operation. In this type of fuel cell, the electrolyte is a polymer which functions as a proton conductor and electrochemically and electronically separates the anode from the cathode compartments. Conventional technology is based on perfluorosulfonic acid (PFSA) membranes that operate at temperatures below 100° C. due to the fact that their conductivity is dependent on the presence of water. At that temperature range, the presence of impurities such as carbon monoxide in the hydrogen have a poisoning effect on the electrocatalyst. Even though new electrocatalysts have been developed for use at a typical operational temperature of 80° C., 50-100 ppm of carbon monoxide can deactivate the catalyst. Since carbon monoxide adsorption to the catalyst is temperature dependent, an increase of the operation temperature above 120° C. would enhance the CO tolerance of the catalyst. U.S. Pat. No. 5,525,436 describes polymer electrolyte membranes based on polybenzimidazole (“PBI”) that can be utilized in fuel cells operating at temperatures above 120° C. PBI combines high thermal stability and high glass transition temperature with the ability to absorb strong inorganic acids like phosphoric and sulfuric acid, resulting in high ionically conducting membranes. These membranes can be used in fuel cells operating at temperatures up to 200° C. One of the main drawbacks of these systems is their low oxidative stability and their moderate mechanical properties. Various attempts have been made to improve the mechanical properties of PBI by using polymer blends composed of PBI and a thermoplastic elastomer (Macromolecules 2000, 33, 7609, WO Patent 01/18894 A2) in order to combine the acid doping ability of the PBI with the exceptional mechanical properties of the thermoplastic elastomer. Additionally, blends of PBI with an aromatic polyether copolymer containing pyridine units in the main chain have also been prepared, resulting in easily doped membranes with excellent mechanical properties and superior oxidative stability (Journal of the Membrane Science 2003, 252, 115). Furthermore, scientific effort has been devoted to the development of alternative low cost polymeric systems that will combine all the desired properties for application in fuel cells operating at temperatures above 120° C. Apart from the preparation of the ideal polymeric material, the construction of high performance gas diffusion electrodes is of great importance. WO 01/18894 describes the preparation of high performance gas diffusion electrodes for high temperature polymer electrolyte fuel cells. The carbon substrate is either carbon paper or carbon cloth. The gas diffusion layer is obtained by treatment of the carbon support with an ink consisting of an hydrophobic polymer solution (e.g. PTFE) and carbon powder. The catalyst layer is applied by a slurry comprised of carbon supported noble metal catalyst and a PBI based polymer binder. The catalyst layers of the gas diffusion anode and cathode are doped with phosphoric acid and hot pressed with the doped polymer electrolyte membrane in order to form the membrane electrode assembly (MEA).

### SUMMARY OF THE INVENTION

The subject invention provides new polymer electrolyte membranes composed of polymer blends of pyridine containing aromatic polyethers. The blends exhibit excellent mechanical properties, high thermal and oxidative stability and high ionic conductivities after doping with phosphoric acid. The invention further relates to the preparation of membrane electrode assemblies based on the previous blends and to their use in PEMFCs.

### BRIEF DESCRIPTION OF THE DRAWINGS

For a fuller understanding of the nature and desired objects of the present invention, reference is made to the following detailed description taken in conjunction with the accompanying drawing figures wherein:

FIG. 1 shows temperature dependence of the storage (E′) and loss modulus (E″) of polymer 1 before (▪) and after (▴) treatment with H₂O₂ and of copolymer 2 before (□) and after (Δ) treatment with H₂O₂;

FIG. 2 shows temperature dependence of the storage (E′) and loss (E″) modulus of polymer 1 (▴), copolymer 2 (▪), polymer 1/copolymer 2 50/50 blend (∘);

FIG. 3 shows temperature dependence of the storage (E′) and loss (E″) modulus of polymer 1/copolymer 2 50/50 (▪), polymer 1/copolymer 2 70/30 () and polymer 1/copolymer 2 80/20 (□) blends after treatment with H₂O₂;

FIG. 4 shows TGA thermogram of polymer 1/copolymer 2 50/50 before (▪) and after (□) treatment with H₂O₂;

FIG. 5 shows time dependence of doping level for different doping times for the polymer 1/copolymer 2 50/50 blend at 50° C. (▪), 80° C. (∘) and 100° C. (▴);

FIG. 6 shows temperature dependence of conductivity of acid doped polymer 1/copololymer 2 50/50 with a doping level of 180 wt %;

FIG. 7 shows I-V curves of polymer 1/copolymer 2 50/50 blend at 130° C. (▪) and 140° C. (∘).

### DEFINITIONS

The following definitions are for convenient reference with respect to the following description and are not to be construed in a limiting manner.

The term Gel Permeation Chromatography (“GPC”) shall be understood to mean or refer to a method or technique used in order to determine the molecular weight (Mn and Mw) and dispersity of the polymers.

The term Nuclear Magnetic Resonance (“NMR”) shall be understood to mean or refer to a method or technique used in order to identify the chemical and molecular structure of the polymers and the proportion of the monomers in the copolymers.

The term Fourier-Transform Infrared Spectroscopy (“FT-IR”) shall be understood to mean or refer to a method or technique used in order to identify the chemical and molecular structure of the polymers in association with NMR data.

The term Dynamic Mechanical Analysis (“DMA”) shall be understood to mean or refer to a method or technique used in order to identify the Tg (glass transition temperature) of the polymers, homopolymers, copolymers and blends.

The term Thermogravimetric Analysis (“TGA”) shall be understood to mean or refer to a method or technique used in order to study the thermal, and oxidative stability before and after Fenton's test as well as before and after doping with acids.

The term Fenton's Test shall be understood to mean or refer to a method or technique used in order to study and determine the oxidative stability of the polymers and their blends.

The term Scanning Electron Microscope (“SEM”) shall be understood to mean or refer to the equipment or instrument used in order to obtain data of the structure in the nano level of the membranes and the degree of compatibility and dispersion of the polymer blends.

The term Single Fuel Cell Test shall be understood to mean or refer to a method or technique used in order to obtain real practical data of the proton conductivity of the polymer electrolyte membranes, and test their fuel cell performance. The single cell test is a quite complex procedure and one important aspect is the MEA preparation. Designing the MEA, several parameters should be taken into account in order to have satisfying performance of the cell. The selection of the catalyst, the specimen of the ionomer, the proportion of catalyst/ionomer, conditions like pressure and temperature, the thickness of the membrane, the doping level and the testing surface of the membrane are some of such parameters. Diversions of these parameters are carried out so as to optimize the cell test for each polymer or polymer blend.

On each side of the doped membrane a gas diffusion electrode is deposited. The catalyst ink consists of the electrolyte and platinum supported on active carbon with varying Pt loading. The GDE consists of “flat type” gas diffusion layer or carbon paper provided by ETEK on which the catalyst ink was deposited by using screen printing or aerography. The membrane electrode assembly is mounted into the 5×5 cm single cell by applying a torque of 9 N*m at each nut of the cell (number of nuts: 8). Each electrode's area is 25 cm². Using a system of a galvanostat/potensiostat, I-V plots are acquired, and using this system in cooperation with a frequency response detector, A.C. impedance measurements are also acquired.

### DETAILED DESCRIPTION OF THE INVENTION

The present invention relates to the development of polymer electrolyte membranes based on blends of aromatic polyethers containing pyridine units in the main chain. These polymeric blends are easily doped with inorganic acids such as phosphoric acid, resulting in ionically conducting membranes. The membranes show excellent mechanical properties and exceptional thermal and oxidative stability. Combination of these polymeric membranes with electrodes that contain the desired amount of the noble metal supported on carbon and the polymeric binder of the same composition as the membrane results in membrane electrode assemblies that can operate at temperatures between 120° C. and 180° C.

The polymer blends are composed of a homopolymer of the structure 1 which is easily doped with phosphoric acid and a copolymer of the structure 2 which provide excellent mechanical properties and the good dimensional stability.

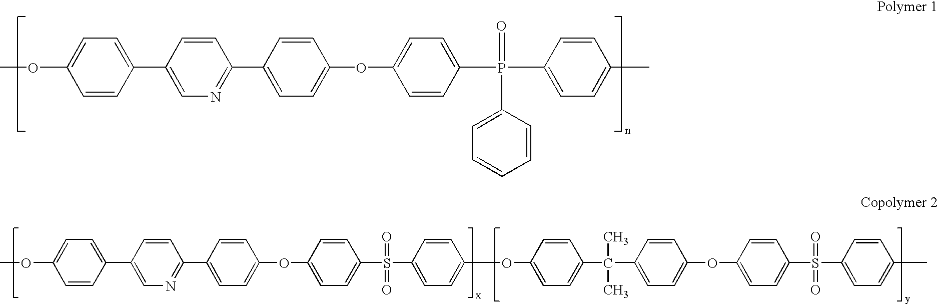

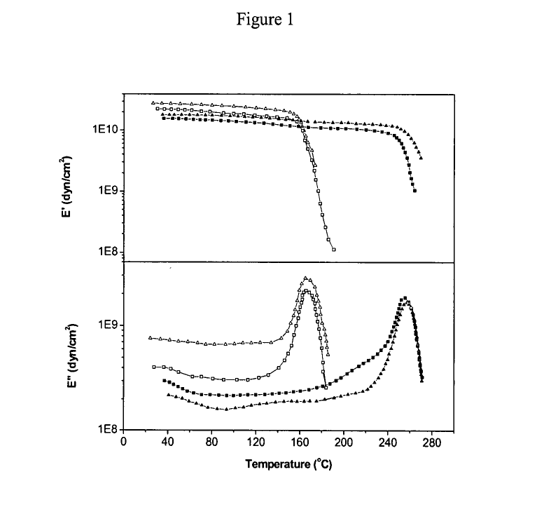

Homopolymer 1 and copolymer 2 are synthesized according to published procedures (Chemistry of Materials 2003, 15(46), 5044, Journal of the Membrane Science 2003, 252, 115) properly modified for the various copolymer compositions. Polymer 1 has high glass transition temperature up to 280° C., while copolymer 2 has glass transition temperature in the range of 160-220° C. depending on the copolymer composition. When the Fenton's test is applied, these polymers and copolymers show exceptional oxidative stability. With this test the membranes are exposed to a strongly oxidative environment. More specifically, membranes are treated with hydrogen peroxide in the presence of ferrous ions at 80° C. for 48 hours. Hydroxyl and hydroperoxy radicals are created which can cause structural changes to polymers through addition to the benzene rings. This could lead to either chain scission or to ring opening. Such structural changes could further affect some physical properties of the materials. However, these polymers and copolymers retain their flexibility and mechanical integrity. This is shown in FIG. 1 where films before and after treatment show identical mechanical spectra.

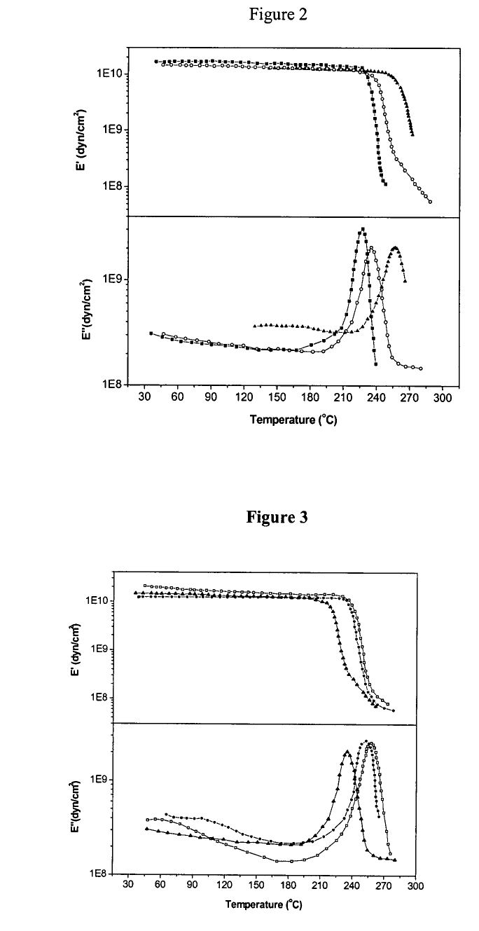

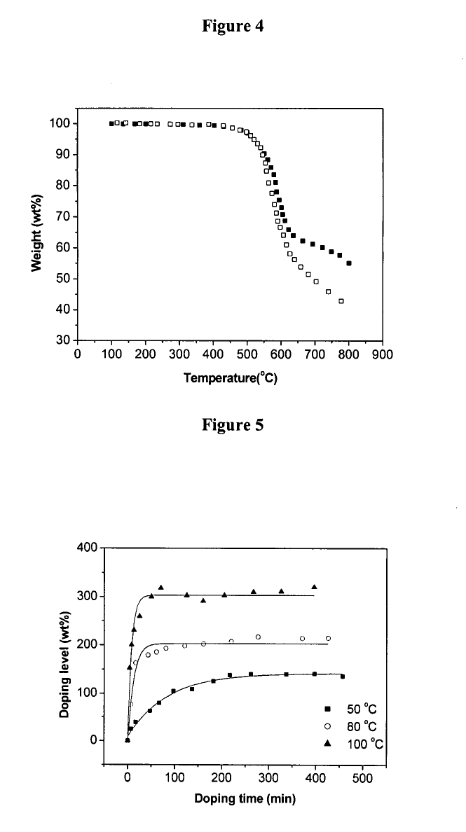

Blends of homopolymer 1 with copolymer 2 at blend compositions ranging from 10:90 to 90:10 and preferably between 20:80 and 80:20 are prepared by mixing dimethylacetamide solution of the respective polymers in the proper ratio. The resulting solutions are stirred at room temperature for 3 hours and then casted on a glass dish. The solvent is evaporated in an oven at 70-120° C., for 24 hours. The membranes are washed with distilled water and dried under vacuum at 170° C. for 72 hours. The miscibility behavior of the blends is then examined through dynamic mechanical analysis using the single glass transition criterion. In most cases, polymer blends are not miscible. However, some polymer pairs are miscible due to some type of specific interactions between the two components. In the present invention, the blends are miscible in most cases. An example is given in FIG. 2 for a 50:50 polymer 1/copolymer 2 blend where a single Tg is observed at a temperature between the pure polymers Tgs denoting the miscibility of this polymer pair. The blend membranes are tested in respect to their oxidative stability using the previously mentioned Fenton's test. In all cases, the blend membranes retain their mechanical integrity and their high thermal stability as shown in FIG. 3 and FIG. 4.

The membranes are doped with phosphoric acid at different temperatures and for different doping times, depending on the membrane composition. The doping level is defined as the weight percent of the acid per gram of the polymer, copolymer or blend. An example of the doping behavior of the membrane of polymer 1/copolymer 2 at a 50/50 blend composition is shown in FIG. 5. As the doping temperature increases the phosphoric acid doping level also increases reaching plateau values for higher doping times. Using phosphoric acid, a doping level is in a range between 100 wt % and 300 wt %, preferably in the range between 180 to 250 wt % is obtained.

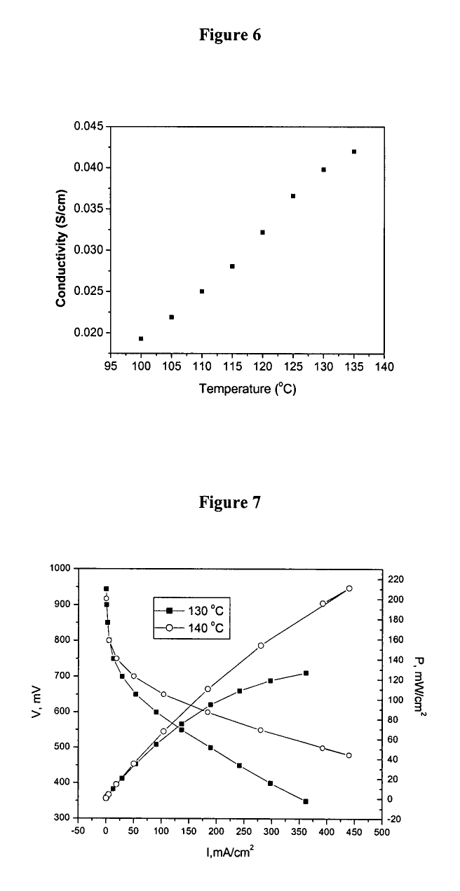

FIG. 6 illustrates the temperature dependence of conductivity of a sample of polymer 1/copolymer 2 at a 50:50 blend doped with 180 wt % phosphoric acid. As shown, conductivity increases as temperature increases and at 135° C., the conductivity is 4.2*10⁻² S/cm.

### Preparation of the MEA

The carbon backing where the gas diffusion electrodes are constructed, is either carbon cloth or carbon paper. The hydrophobic sublayer, which is applied onto the carbon substrate, consists of carbon black (20-70 wt %) containing a hydrophobic polymer (30-80 wt %). More specifically, an emulsion of polytetrafluoroethylene (PTFE) is mechanically mixed with carbon black for 30 minutes. The bulk of the solvent is removed by filtration. The slurry is applied onto the carbon paper or cloth. After sintering at a temperature of 350° C. for 30 minutes, this layer is rendered hydrophobic.

Carbon supported noble metal (Pt) catalyst, is mechanically mixed with a dimethylacetamide polymer solution until the catalyst is uniformly distributed. The weight ratio of the noble metal to carbon is about 1:9 to 4:6, most preferably 3:7, while the concentration of the polymer solution is 1-4 wt %. The selected polymer is either a pure polymer or a blend. The weight ratio of the noble metal to the ionomer is 7:3 to 1:1. The Pt/C/ionomer slurry is obtained after evaporation of the solvent. The slurry is then applied onto the gas diffusion layer. Sufficient fluidity of the slurry ensures that the resulting surface of the catalyst layer is appropriate. The electrodes are finally dried under vacuum in an oven at temperature of 190° C. for 1-2 hours and the final noble metal loading is 0.5-1 mg/cm².

The membrane electrode assembly is prepared by pressing the gas diffusion anode, the gas diffusion cathode and the doped polymer membrane into a 5×5 cm single cell by applying a torque of 9 N*m at each nut of the cell (total of 8 nuts). The electrodes area is therefore 25 cm². The membrane is then doped with phosphoric acid at a doping level of 150 to 250 wt % and its thickness after doping varies from 90-200 μm.

The following non-limiting examples are illustrative of the invention. All documents mentioned herein are incorporated herein by reference.

### EXAMPLE 1

0.5 g of polymer 1 is dissolved in 10 ml dimethylacetamide and 0.5 g of copolymer 2 is also dissolved in 10 ml dimethylacetamide at room temperature. The two solutions are mixed and stirred at room temperature for 3 hours. The solution is filtrated through glasswool and poured into a 100 mm diameter glass dish. The solvent is slowly evaporated in an oven at 80° C. for 24 hours and the membrane is washed with water and dried at 170° C. for 48 hours under vacuum. The membrane is immersed in 85 wt % phosphoric acid at 80° C. for 2 hours in order to reach a doping level of 200 wt %.

### EXAMPLE 2

0.7 g of polymer 1 is dissolved in 14 ml dimethylacetamide and 0.3 g of copolymer 2 is also dissolved in 6 ml dimethylacetamide at room temperature. The two solutions are mixed and stirred at room temperature for 3 hours. The solution is filtrated through glasswool and poured into 100 mm diameter glass dish. The solvent is slowly evaporated in an oven at 80° C. for 24 hours and the membrane is washed with water and dried at 170° C. for 48 hours under vacuum. The membrane is immersed in 85 wt % phosphoric acid at 80° C. for 5 hours in order to reach a doping level of 320 wt %.

### EXAMPLE 3

A slurry of 70 wt % carbon powder and 30 wt % PTFE is applied onto carbon cloth. The resulting hydrophobic layer is dried and sintered at 350° C. for 30 minutes. A mixture of 50 wt % Pt from a Pt/C 28.6% catalyst powder and 50 wt % polymer 1 from a 3 wt % polymer solution in dimethylacetamide, is well mixed and applied onto the supporting layer of the carbon cloth. The electrodes are first dried at 80° C. for 20 hours and at 190° C. for 1 hour under vacuum. The platinum loading in the catalyst layer of the anode and the cathode is 1 mg/cm².

For the preparation of the MEA, a blend of polymer 1/copolymer 2 50/50 is doped with phosphoric acid at a doping level of 150 wt %. The membrane thickness is 80 μm after the doping. The membrane electrode assembly is mounted into the 5×5 cm single cell by applying a torque of 9 N*m at each nut of the cell (total of 8 nuts). The electrodes' area is therefore 25 cm².

### EXAMPLE 4

As mentioned above, the assembly is mounted in the 5×5 cm single cell. Current density versus cell voltage curves are measured at each temperature after the cell performance reaches a steady state. Dry hydrogen and oxygen are supplied under atmospheric pressure. FIG. 7 shows the I-V plots at temperatures between 130-140° C. At 140° C., a current output of 395 mA/cm² is obtained at a cell voltage of 500 mV. This cell performance is comparable to bibliographic reports for PBI, (e.g. a current output of 400 mA/cm² at 500 mV at 150° C., Electrochim. Acta 1996, 41, 193.) and other high temperatures electrolytes such as PBI/SPSF(Na)₃₆ 50/50, which at 130° C., a current output of 300 mA/cm² was obtained at a cell voltage of 500 mV (Macromolecules 2000, 33, 7609).

What is claimed is:

1. A method for the preparation of a polymer electrolyte membrane, the method comprising:
a. blending a first pyridine-containing aromatic polyether with a second aromatic pyridine-containing aromatic polyether to form a blend; and
b. preparing a polymer electrolyte membrane using the blend;
wherein each of the first and second pyridine-containing aromatic polyethers comprises pyridine units in the main chain of the polyether.

2. The method of claim 1, wherein the blend comprises 10-90 wt % of Polymer 1 (poly(2,5-diphenyloxy pyridinyl biphenyl)phenylphosphine oxide) and 90-10 wt % of Copolymer 2 (poly{2,5-diphenyloxy pyridinyl biphenyl sulfone)-co-(4,4′-isopropylidene diphenol biphenyl sulfone}).

3. The method of claim 2, wherein the blend comprises about 50 wt % of Polymer 1 and about 50 wt % of Copolymer 2.

4. The method of claim 1, wherein the blend is doped with a polyprotic acid.

5. The method of claim 4, wherein the polyprotic acid is phosphoric acid.

6. The method of claim 5, wherein a doping level of the polyprotic acid is greater than 150 wt %.

7. A polymer composition comprising a first pyridine-containing aromatic polyether and a second aromatic pyridine-containing aromatic polyether, wherein each of the first and second pyridine-containing aromatic polyethers comprises pyridine units in the main chain of the polyether.

8. The polymer blend of claim 7, wherein the blend comprises 10-90 wt % of Polymer 1 and 90-10 wt % of Copolymer 2.

9. The polymer blend of claim 8, wherein the blend comprises about 50 wt % of Polymer 1 and about 50 wt % of Copolymer 2.

10. The polymer blend of claim 7, wherein the blend is doped with a polyprotic acid.

11. The polymer blend of claim 10, wherein the polyprotic acid is phosphoric acid.

12. The polymer blend of claim 11, wherein a doping level of the polyprotic acid is greater than 150 wt %.

13. A method for preparing a catalyst layer, the method comprising combining a polymer composition of claim 7 with a carbon/oxide supported metal catalyst to form a catalyst blend composition; and preparing a catalyst layer with the catalyst blend composition.

14. The method of claim 13, wherein the catalyst blend comprises 30-60 wt % catalyst powder and 70-40 wt % of the polymer composition.

15. A composition comprising a slurry mixture of a polymer composition of claim 7 and a carbon/oxide supported metal catalyst.

16. The composition of claim 15, wherein the composition comprises 30-60 wt % catalyst powder and 70-40 wt % of the polymer composition.

17. The composition of claim 16, wherein carbon/oxide supported metal catalyst is platinum.

18. The composition of claim 16, wherein carbon/oxide supported metal catalyst is PtRu.

19. The method of claim 14 or composition of claim 15, wherein the polymer composition comprises about 50 wt % of Polymer 1 and about 50 wt % of Copolymer 2.

20. The method of preparing a catalyst, the method comprising:
a. depositing a layer of a composition of claim 15 by tape casting or spraying on a hydrophibic layer; and
b. drying and sintering the layer deposited in step (a), thereby preparing the catalyst.

21. A cathode electrode prepared by the method of claim 20, wherein the carbon/oxide supported metal catalyst is Pt.

22. An anode electrode prepared by the method of claim 20, wherein the carbon/oxide supported metal catalyst is PtRu.

23. A membrane electrode assembly comprising;
a cathode electrode of claim 21;
an anode electrode of claim 22; and
a solid polymer electrolyte composition of claim 7.

24. A hydrogen fuel cell comprising a membrane electrode assembly according to claim 23 operating at temperatures 100-180° C.
